(19) United States
(12) Patent Application Publication
(10) Pub. No.: US 2018/0299889 A1
(43) Pub. Date: Oct. 18, 2018

(54) CONTENT REPRODUCTION DEVICE AND CONTENT REPRODUCTION METHOD

(71) Applicant: DENSO TEN Limited, Kobe-shi (JP)

(72) Inventor: Yohei YOKOTA, Kobe-shi (JP)

(73) Assignee: DENSO TEN Limited, Kobe-shi (JP)

(21) Appl. No.: 15/886,268

(22) Filed: Feb. 1, 2018

(30) Foreign Application Priority Data
Apr. 17, 2017 (JP) 2017-081593

(51) Int. Cl. G05D 1/00; B60W 50/14

(52) U.S. Cl. CPC G05D 1/0061; G05D 2201/0213; B60W 50/14

(57) ABSTRACT

There is provided a content reproduction device. An acquisition unit configured to acquire driving information indicating whether a vehicle driving is a manual driving in which a driver should execute a driving operation or an automatic driving in which the driver does not have to execute the driving operation. A change unit that is configured to determine whether the vehicle driving is to be switched from the automatic driving to the manual driving on the basis of the driving information acquired by the acquisition unit and that, when the vehicle driving is switched from the automatic driving to the manual driving, changes at least one of a content to be reproduced and a setting about reproduction.

### CROSS-REFERENCE TO RELATED APPLICATION

This application is based on and claims priority under 35 USC 119 from Japanese Patent Application No. 2017-81593 filed on Apr. 17, 2017.

### TECHNICAL FIELD

The present invention related to a content reproduction device and a content reproduction method.

### RELATED ART

In recent years, research and development regarding automatic driving have been actively carried out. Regarding the automatic driving, there are diverse levels. For example, according to the definitions of American SAE (Society of Automotive Engine ers), Level 1 (driving assistance) and Level 2 (partial automation) indicate a state where a driver executes some driving operations and an automatic driving system executes the other driving operations, and Level 3 (conditional automation) and Level 4 (advance automation) indicate a state where the automatic driving system executes all the driving operations under specific conditions.

When a vehicle is traveling at a state of Level 3 or Level 4, since the driver does not execute the driving operation at all under specific conditions, the driver can enjoy contents that cannot be enjoyed when the driver executes the driving operation.

Patent Document: JP-A-2016-137819 (paragraph 0118)

When the specific conditions are not satisfied at the state of Level 3 (conditional automation) and Level 4 (advanced automation), a situation where the driver should execute at least some of the driving operations occurs. At this time, in order for the driver to cope with a manual driving, it is preferable to notify the driver that the vehicle driving is to be switched from the automatic driving to the manual driving, through a notification device in a vehicle (for example, refer to Patent Document 1).

However, when the driver concentrates on the content during the automatic driving, even if the notification as described above is made, the driver is difficult to recognize the same.

### SUMMARY

It is therefore an object thereof is to provide a technology by which it is possible to appropriately notify a user that a vehicle driving is to be switched from an automatic driving to a manual driving.

According to an aspect of the embodiments of the present invention, a content reproduction device includes an acquisition unit configured to acquire driving information indicating whether a vehicle driving is a manual driving in which a driver should execute a driving operation or an automatic driving in which the driver does not have to execute the driving operation, and a change unit that is configured to determine whether the vehicle driving is to be switched from the automatic driving to the manual driving on the basis of the driving information acquired by the acquisition unit and that, when the vehicle driving is switched from the automatic driving to the manual driving, changes at least one of a content to be reproduced and a setting about reproduction.

In the content reproduction device, the driving information may include pre notice information, which notices in advance that the vehicle driving is to be switched from the automatic driving to the manual driving, and the change unit may change at least one of the content to be reproduced and the setting about reproduction into a first changed content after a notice is made by the pre notice information until the vehicle driving is actually switched from the automatic driving to the manual driving, and change at least one of the content to be reproduced and the setting about reproduction into a second changed content different from the first changed content at a point of time at which the vehicle driving is switched from the automatic driving to the manual driving.

In the content reproduction device, the content reproduction device may include an operation unit that is to be operated by a user, and a determination unit configured to determine whether the user has an intention to switch the vehicle driving from the automatic driving to the manual driving, based on an operation content performed on the operation unit for changing at least one of the content to be reproduced and the setting about reproduction.

In the content reproduction device, the determination unit may be configured to determine whether the user has an intention to switch the vehicle driving from the automatic driving to the manual driving, based on a traveling situation of the vehicle.

In the content reproduction device, when the vehicle driving is switched from the automatic driving to the manual driving in correspondence to a determination result of the determination unit, and when the vehicle driving is switched from the automatic driving to the manual driving, irrespective of the determination result of the determination unit, contents of the change, which is to be executed by the change unit, may be different.

According to an aspect of the embodiments of the present invention, a content reproduction method includes an acquisition process of acquiring driving information indicating whether a vehicle driving is a manual driving in which a driver should execute a driving operation or an automatic driving in which the driver does not have to execute the driving operation, and a change processing of determining whether the vehicle driving is to be switched from the automatic driving to the manual driving on the basis of the driving information acquired by the acquisition unit and, when the vehicle driving is switched from the automatic driving to the manual driving, changing at least one of a content to be reproduced and a setting about reproduction.

According to the aspect of the embodiments of the present invention, it is possible to appropriately notify the user that the vehicle driving is to be switched from the automatic driving to the manual driving.

### BRIEF DESCRIPTION OF THE DRAWINGS

Exemplary embodiments of the present invention will be described in detail based on the following figures, wherein:

FIG. 1 depicts an example of a schematic configuration of an automatically drivable vehicle;

FIG. 2 depicts an example of a configuration of a content reproduction device;

FIG. 3 is a flowchart depicting an operation example of the content reproduction device shown in FIG. 2;

FIG. 4 depicts an example of changing a content to be reproduced;

FIG. 5 depicts another example of the configuration of the content reproduction device;

FIG. 6 is a flowchart depicting an operation example of the content reproduction device shown in FIG. 5; and

FIG. 7 depicts an example of a confirmation screen.

### DETAILED DESCRIPTION

Hereinafter, exemplary illustrative embodiments of the present disclosure will be described in detail with reference to the drawings.

### 1. Example of Schematic Configuration of Automatically Drivable Vehicle

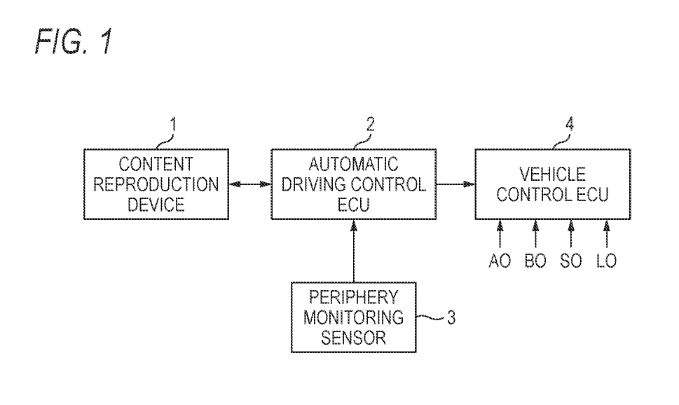

FIG. 1 depicts an example of a schematic configuration of an automatically drivable vehicle. The automatically drivable vehicle includes a content reproduction device 1, an automatic driving control ECU (Electric Control Unit) 2, a periphery monitoring sensor 3, and a vehicle control ECU 4.

The content reproduction device 1 is a device configured to reproduce contents such as a moving picture, a music, a map image and the like, and can perform communication with the automatic driving control ECU 2. The content reproduction device 1 will be described in detail later.

The automatic driving control ECU 2 is configured to select any one of a manual driving in which a driver should execute a driving operation and an automatic driving in which the driver does not have to execute the driving operation. Also, the automatic driving control ECU 2 is configured to generate a control signal on the basis of a monitoring result of the periphery monitoring sensor 3 and to output the control signal to the vehicle control ECU 4 during the automatic driving.

The periphery monitoring sensor 3 is an imaging device, a millimeter wave radar or the like, for example, and is configured to monitor a situation around the vehicle.

The vehicle control ECU 4 is configured to control a direction, a speed and the like of the vehicle, based on a signal AO indicative of an operating amount of an accelerator pedal of the vehicle by a driver, a signal BO indicative of an operating amount of a brake pedal of the vehicle by the driver, a signal SO indicative of an operating amount of a steering of the vehicle by the driver, and a signal LO indicative of an operating content of a shift lever of the vehicle by the driver during the manual driving. In the meantime, the vehicle control ECU 4 may be configured to use a control signal, which is to be output from the automatic driving control ECU 2, instead of some signals of the signals AO, BO, SO and LO, during the manual driving. In the meantime, the vehicle control ECU 4 is configured to control the direction, the speed and the like of the vehicle, based on a control signal, which is to be output from the automatic driving control ECU 2, during the automatic driving. The control signal, which is to be output from the automatic driving control ECU 2 to the vehicle control ECU 4 during the automatic driving, includes an acceleration parameter corresponding to an operating amount of the accelerator pedal, which is to be varied by a driving operation of the driver during the manual driving, a deceleration parameter corresponding to an operating amount of the brake pedal, which is to be varied by a driving operation of the driver during the manual driving, a steering angle parameter corresponding to an operating amount of the steering, which is to be varied by a driving operation of the driver during the manual driving, and a shift parameter corresponding to an operating content of the shift lever of the vehicle by the driver.

That is, while the driver performs at least some of the driving operations of the vehicle during the manual driving, the automatic driving control ECU 2 performs all of the driving operations of the vehicle during the automatic driving.

### 2. Example of Configuration of Content Reproduction Device

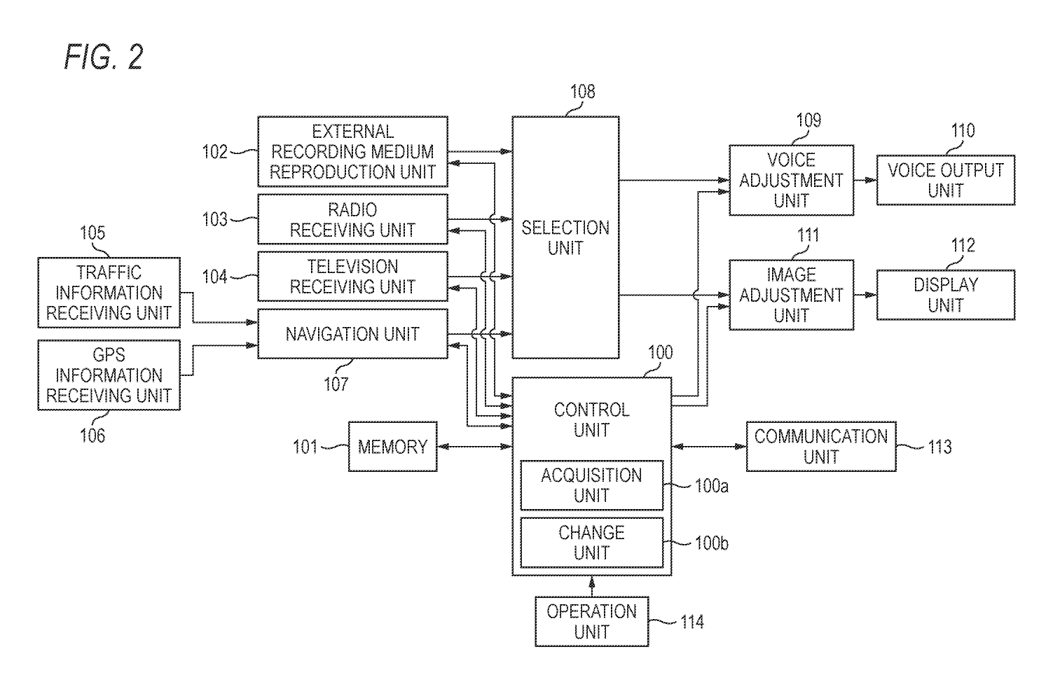

FIG. 2 depicts an example of a configuration of the content reproduction device 1. The content reproduction device 1 shown in FIG. 2 includes a control unit 100, a memory 101, an external recording medium reproduction unit 102, a radio receiving unit 103, a television receiving unit 104, a traffic information receiving unit 105, a GPS (global positioning system) information receiving unit 106, a navigation unit 107, a selection unit 108, a voice adjustment unit 109, a voice output unit 110, an image adjustment unit 111, a display unit 112, a communication unit 113, and an operation unit 114.

The control unit 100 is configured to input a signal from each unit of the content reproduction device 1 or an external device connected to the content reproduction device 1, an operation instruction signal from the operation unit 114 corresponding to a user's operation, and the like, and to collectively control each unit of the content reproduction device 1 or the external device connected to the content reproduction device 1 on the basis of the signals. The control unit 100 includes a microcomputer, for example, and is configured to implement each function as the microcomputer executes a variety of programs stored in the memory 101.

The memory 101 is a memory embedded in the content reproduction device 1 and is a memory configured to store therein a variety of data and a variety of programs. The diverse data includes map information, which is to be used in the navigation unit 107, too.

The external recording medium reproduction unit 102 is configured to read out and reproduce data of a content recorded in an external recording medium. The external recording medium includes an SD card, a CD (Compact Disc), a DVD (Digital Versatile Disc), a Blu-ray (registered trademark) Disc and the like. The external recording medium includes a music reproduction device having a recording medium, too.

The radio receiving unit 103 is configured to select, receive and demodulate a broadcast wave of a specific frequency from AM or FM broadcast waves transmitted from each radio station and received by a radio receiving antenna (not shown) and to output a voice signal of the selected radio station. That is, the radio receiving unit 103 is configured to reproduce radio broadcast contents.

The television receiving unit 104 is configured to receive and demodulate a broadcast wave of a specific frequency from broadcast waves transmitted from each broadcast station and received by a television receiving antenna (not shown) and to output an image signal, a voice signal and a data signal of the selected broadcast station. That is, the television receiving unit 104 is configured to reproduce television broadcast contents.

The traffic information receiving unit 105 is configured to receive traffic information, which is to be provided by a traffic information communication system (VICS; registered trademark), and to output the received traffic information, for example.

The GPS information receiving unit 106 is configured to detect a position of the own vehicle on the basis of GPS signals from GPS satellites, and to output the detected current position information.

The navigation unit 107 is configured to guide a path to a destination by displaying a position of the own vehicle and a path to a destination on a map, guiding a traveling direction such as a right turn, a left turn or the like at the intersection and the like by a voice and the like, and receiving and displaying the traffic information from the traffic information receiving unit 105.

The selection unit 108 is configured to select a voice signal and an image signal of the diverse sources (the external recording medium reproduction unit 102, the radio receiving unit 103, the television receiving unit 104, and the navigation unit 107), for which an output is designated, and to output the same to the voice adjustment unit 109 and the image adjustment unit 111, based on a control signal of the control unit 100.

The voice adjustment unit 109 is configured to adjust a volume and a sound quality of a voice signal, which is to be output from the selection unit 108 or the control unit 100, and to output the adjusted voice signal.

The voice output unit 110 is a speaker, for example, and is configured to convert the voice signal output from the voice adjustment unit 109 into a voice and to output the voice.

The image adjustment unit 111 is configured to adjust a brightness, a color tone, a contrast and the like of an image signal, which is to be output from the selection unit 108 or the control unit 100, and to output the adjusted image signal. The image adjustment unit 111 is also configured to synthesize an image signal output from the selection unit 108 and an image signal output from the control unit 100, as necessary.

The display unit 112 is a liquid crystal monitor or an organic EL display, for example, and is configured to perform a display on the basis of the image signal output from the image adjustment unit 111.

The communication unit 113 is configured to perform communication with the automatic driving control ECU 2 shown in FIG. 1.

The operation unit 114 is a touch panel or a push button switch, for example, and is configured to receive an operation for changing at least one of a content to be reproduced and a setting about reproduction.

### 3. Operation Example of Content Reproduction Device

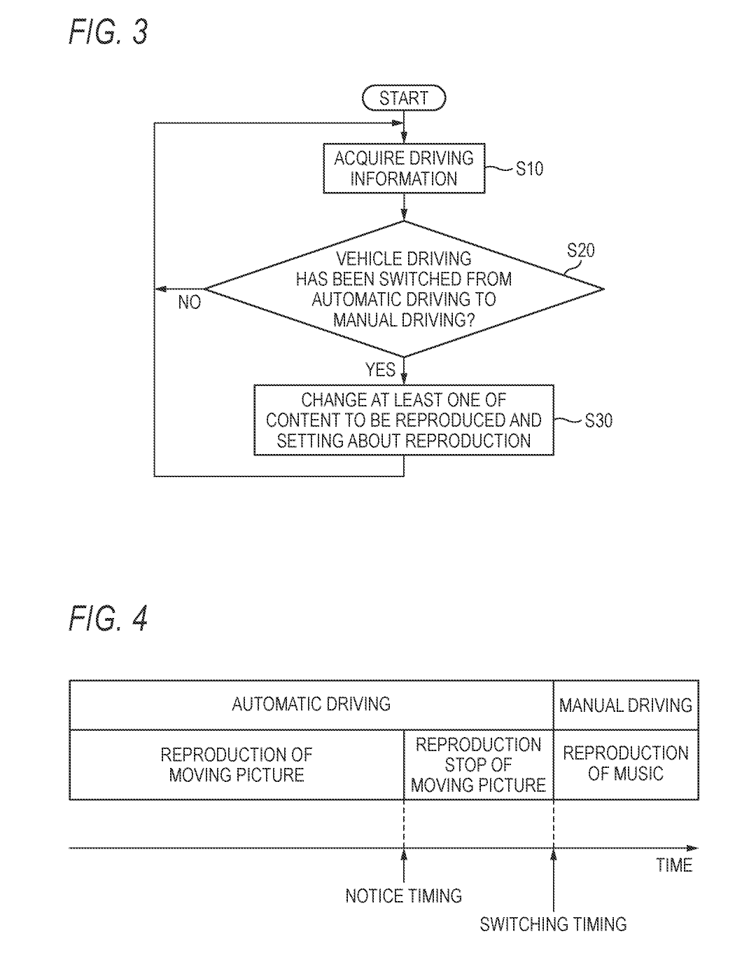

FIG. 3 is a flowchart depicting an operation example of the content reproduction device shown in FIG. 2. The content reproduction device 1 shown in FIG. 2 starts a flow operation shown in FIG. 3 when a power supply is switched from an off state to an on state.

First, an acquisition unit 100a of the control unit 100 acquires driving information from the automatic driving control ECU 2 shown in FIG. 1 via the communication unit 113 (step S10). The driving information is information indicating whether the vehicle driving is the manual driving in which the driver should execute the driving operation or the automatic driving in which the driver doesn't have to execute the driving operation. In the meantime, the driving information preferably includes pre notice information for noticing that the vehicle driving is to be switched from the automatic driving to the manual driving.

Then, a change unit 100b of the control unit 100 determines whether the vehicle driving is to be switched from the automatic driving to the manual driving, based on the driving information acquired by the acquisition unit 100a (step S20).

When it is determined that the vehicle driving is not to be switched from the automatic driving to the manual driving, the control unit 100 returns to step S10.

On the other hand, when it is determined that the vehicle driving is to be switched from the automatic driving to the manual driving, the change unit 100b changes at least one of a content to be reproduced and a setting about reproduction (step S30), and then returns to step S10. Thereby, even when the user concentrates on the content being reproduced during the automatic driving, a notification can be securely transmitted to the user. Therefore, for example, even when the user concentrates on the content during the automatic driving, the driver can easily recognize that the vehicle driving is to be switched from the automatic driving to the manual driving.

In step S30, when changing a content to be reproduced, it is preferable to switch the reproduction from reproduction of a content, which is not proper for the manual driving, to reproduction of a content, which is proper for the manual driving, for example. As the content, which is not proper for the manual driving, a moving picture, a drowsy music and the like may be exemplified. As the content, which is proper for the manual driving, a map image, a non-drowsy music and the like may be exemplified.

Also, in step S30, when changing a setting about reproduction, it is preferable to switch the setting from a setting about reproduction, which is not proper for the manual driving, to a setting about reproduction, which is proper for the manual driving, for example. As the setting about reproduction, which is not proper for the manual driving, a setting of reproducing both an image and a voice upon reproduction of a moving picture, a setting of a volume of a threshold or greater upon reproduction of a music, and the like may be exemplified. As the setting about reproduction, which is proper for the manual driving, a setting of reproducing only a voice upon reproduction of a moving picture, a setting of a volume smaller than a threshold upon reproduction of a music, and the like may be exemplified.

When the driving information includes the pre notice information, the change unit 100b preferably changes at least one of the content to be reproduced and the setting about reproduction into a first changed content after a notice is made by the pre notice information until the vehicle driving is actually switched from the automatic driving to the manual driving, and changes at least one of the content to be reproduced and the setting about reproduction into a second changed content different from the first changed content at a point of time at which the vehicle driving is switched from the automatic driving to the manual driving. Thereby, the driver can recognize in advance that the vehicle driving is to be switched from the automatic driving to the manual driving by the first changed content, and can sufficiently secure a preparation for the manual driving.

In the meantime, from a standpoint of securing a preparation time period for the manual driving to the maximum, the change unit 100b more preferably changes at least one of the content to be reproduced and the setting about reproduction into the first changed content at a point of time at which a notice is made by the pre notice information. For example, as shown in FIG. 4, it is preferably to change the reproduction of a moving picture to the reproduction stop of a moving picture at a point of time (at notice timing) at which a notice is made by the pre notice information, and to change the reproduction stop of a moving picture to the reproduction of a music at a point of time (at switching timing) at which the vehicle driving is actually switched from the automatic driving to the manual driving.

Also, when a reproduction ending time of a moving picture is determined in advance, a reproduction speed may be changed to be faster than a current speed so that the reproduction of a moving picture is to be over until the switching is made.

Also, during a time period (a time period from the notice timing to the switching timing) for which the reproduction of a moving picture is stopped, a still image of one frame configuring the moving picture may be reproduced or the reproduction of a content may be stopped. That is, the change from the reproduction of a content to the non-reproduction is also included in the change of a content to be reproduced.

From a standpoint of urging the driver to make a preparation for the manual driving, a notification for urging the user to make a preparation for the manual driving, such as “Please, return to the driving” may be made by at least one of a voice output of the voice output unit 110 and a display of the display unit 112 during the time period from the notice timing to the switching timing.

### 4. Another Example of Configuration of Content Reproduction Device

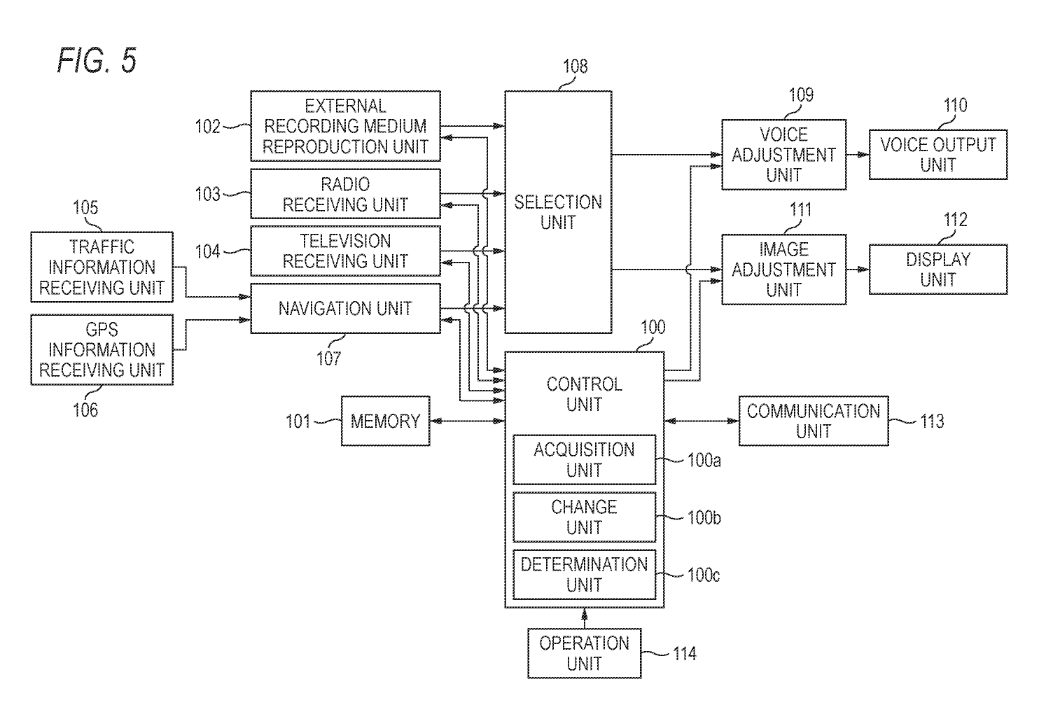

FIG. 5 depicts another example of the configuration of the content reproduction device 1. The configuration shown in FIG. 5 is different from the configuration shown in FIG. 2, in that the control unit 100 includes a determination unit 100c, and the others are the same as the configuration shown in FIG. 2. In the below, the descriptions of the same parts as FIG. 2 are omitted.

The determination unit 100c is configured to determine whether the user has an intention to switch the vehicle driving from the automatic driving to the manual driving, based on an operation content performed on the operation unit 114 for changing at least one of the content to be reproduced and the setting about reproduction. By using a result of the determination, since it is possible to switch the vehicle driving from the automatic driving to the manual driving in accordance with a user's intention even though an interface by which the user directly instructs the switching from the automatic driving to the manual driving is not provided, the convenience is improved. Therefore, the control unit 100 is preferably configured to transmit a switching command from the automatic driving to the manual driving, which is based on a determination result of the determination unit 100c, to the automatic driving control ECU 2 via the communication unit 113.

Also, the determination unit 100c is preferably configured to determine whether the user has an intention to switch the vehicle driving from the automatic driving to the manual driving, based on not only an operation content performed on the operation unit 114 for changing at least one of the content to be reproduced and the setting about reproduction but also a traveling situation of the vehicle. Thereby, it is possible to improve the determination precision of the determination unit 100c. The determination unit 100c is configured to perceive the traveling situation of the vehicle by using map information stored in the memory 101, an expected traveling path calculated by the navigation unit 107, traffic information received by the traffic information receiving unit 105, position information received by the GPS information receiving unit 106, information detected by the periphery monitoring sensor 3, and the like, for example.

For example, in case that a destination is set by the navigation unit 107 and an operation for reproducing a map image is performed before the vehicle enters a general road, on which the automatic driving is impossible, from an express highway on which the automatic driving is possible, since a possibility that the user checked the map image so as to perform the manual driving is high, it may be determined that the user has an intention to switch the vehicle driving from the automatic driving to the manual driving. On the other hand, for example, in case that a destination is set by the navigation unit 107 and an operation for reproducing a map image is performed on an expected traveling path of an express highway on which the automatic driving is possible, since a possibility that the user simply checked a current position is high, it may be determined that the user has no intention to switch the vehicle driving from the automatic driving to the manual driving.

For example, when an operation for reproducing a map image or an operation for stopping on the way reproduction of a content, which is not proper for the manual driving, is performed during traffic jam-up, since a possibility that the user does not want to perform the manual driving during the traffic jam-up is high, it may be determined that the user has no intention to switch the vehicle driving from the automatic driving to the manual driving. On the other hand, for example, when an operation for reproducing a map image or an operation for stopping on the way reproduction of a content, which is not proper for the manual driving, is performed during the non-traffic jam-up, since a possibility that the user makes a preparation for the manual driving is high, it may be determined that the user has an intention to switch the vehicle driving from the automatic driving to the manual driving.

For example, when an operation for reproducing a map image or an operation for stopping on the way reproduction of a content, which is not proper for the manual driving, is performed while it is raining, since a possibility that the user does not want to perform the manual driving while it is raining is high, it may be determined that the user has no intention to switch the vehicle driving from the automatic driving to the manual driving. On the other hand, for example, when an operation for reproducing a map image or an operation for stopping on the way reproduction of a content, which is not proper for the manual driving, is performed while it is not raining, since a possibility that the user makes a preparation for the manual driving is high, it may be determined that the user has an intention to switch the vehicle driving from the automatic driving to the manual driving.

As a result of the determination, for example, a content for enabling the user to select whether or not to switch the vehicle driving from the automatic driving to the manual driving is displayed on the display unit 112. The user having checked the displayed content selects whether to continue the automatic driving or to switch the vehicle driving to the manual driving. Also, the information after the selection may be stored so that a user's selection tendency corresponding to a variety of conditions is learned and a display timing of the content to be selected is adjusted. That is, at timing at which it is determined through the learning that the switching is not required, the content for enabling the user to select whether or not to switch the vehicle driving from the automatic driving to the manual driving may not be displayed on the display unit 112.

<Another Operation Example of Content Reproduction Device>

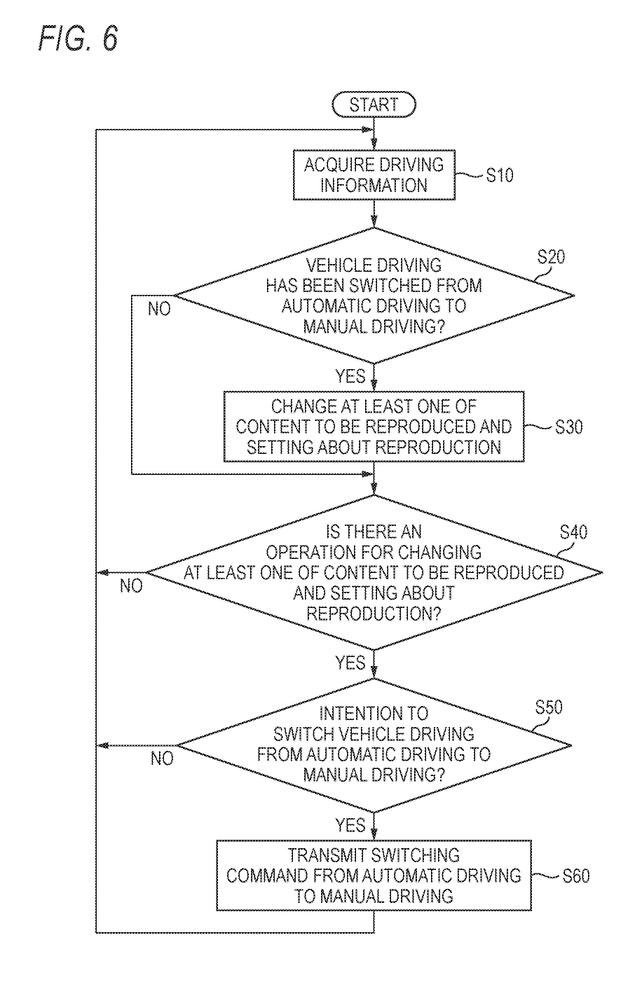

FIG. 6 is a flowchart depicting an operation example of the content reproduction device 1 shown in FIG. 5. In the flow operation shown in FIG. 6, steps S40 to S50 are added to the flow operation shown in FIG. 3. In the below, the descriptions of the same parts as FIG. 3 are omitted.

In the flow operation shown in FIG. 6, when it is determined in step S20 that the vehicle driving is not switched from the automatic driving to the manual driving and when the processing of step S30 is over, the control unit 100 proceeds to step S40 without returning to step S10. In the meantime, unlike the flow operation shown in FIG. 6, only when it is determined in step S20 that the vehicle driving is not switched from the automatic driving to the manual driving, the control unit 100 may proceed to step S40, and when the processing of step S30 is over, the control unit 100 may return to step S10.

In step S40, the control unit 100 determines whether an operation for changing at least one of the content to be reproduced and the setting about reproduction has been performed on the operation unit 114. When it is determined that an operation for changing at least one of the content to be reproduced and the setting about reproduction has not been performed, the control unit 100 returns to step S10. On the other hand, when it is determined that an operation for changing at least one of the content to be reproduced and the setting about reproduction has been performed, the control unit 100 proceeds to step S50.

In step S50, the determination unit 100c of the control unit 100 determines whether the user has an intention to switch the vehicle driving from the automatic driving to the manual driving, based on the operation content performed on the operation unit 114 for changing at least one of the content to be reproduced and the setting about reproduction. Meanwhile, in the determination of step S50, the determination is preferably performed, considering the traveling situation of the vehicle, too, as described above.

When it is determined that the user has no intention to switch the vehicle driving from the automatic driving to the manual driving, the control unit 100 returns to step S10. On the other hand, when it is determined that the user has an intention to switch the vehicle driving from the automatic driving to the manual driving, the control unit 100 proceeds to step S60.

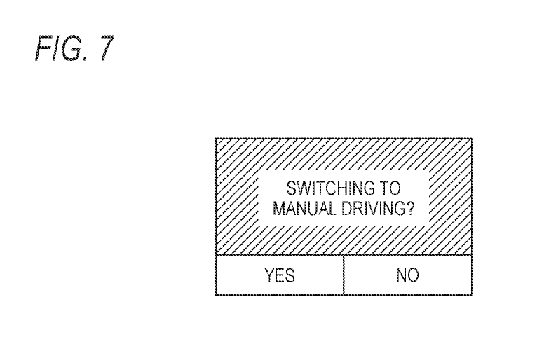

In step S60, the control unit 100 generates a command signal for instructing the switching from the automatic driving to the manual driving, and transmits the command signal to the automatic driving control ECU 2 via the communication unit 113. When the processing of step S60 is over, the control unit 100 returns to step S10. In the meantime, as measures against erroneous determination in step S50, when it is determined that the user has no intention to switch the vehicle driving from the automatic driving to the manual driving, the control unit 100 may make a display as shown in FIG. 7 on the display unit 112, instead of immediately proceeding to step S60, and the control unit 100 may not proceed to step S60 until “Yes” of the display shown in FIG. 7 is selected by an operation on the operation unit 114.

Also, when the vehicle driving is switched from the automatic driving to the manual driving in correspondence to the determination result of the determination unit 100c, and when the vehicle driving is switched from the automatic driving to the manual driving, irrespective of the determination result of the determination unit 100c, the contents of the change, which is to be executed by the change unit 100b in step S30, are preferably different. For example, when the vehicle driving is switched from the automatic driving to the manual driving, irrespective of the determination result of the determination unit 100c, the change, which is to be executed by the change unit 100b, is abruptly performed for the user. Therefore, at this time, a mild change (for example, a change in which a volume difference is small before and after the change), as compared to the case where the vehicle driving is switched from the automatic driving to the manual driving in correspondence to the determination result of the determination unit 100c, may be performed so that the user is not to be surprised. Alternatively, to the contrary, a stimulating change, as compared to the case where the vehicle driving is switched from the automatic driving to the manual driving in correspondence to the determination result of the determination unit 100c, may be performed so that the user cannot perceive the change.

### 6. Modified Embodiments

The above illustrative embodiment is exemplary in every respect and should not be constructed as limitative. The technical scope of the present disclosure is defined in the claims, not in the descriptions of the illustrative embodiment, and should be understood to include all changes within the claims and equivalents thereto.

For example, a portable terminal having a function of reproducing the contents may be used in the vehicle, instead of the content reproduction device 1. The portable terminal is a portable electronic device that is to be carried by the user. For example, a smart phone, a tablet, a portable phone, a PDA (Personal Digital Assistant) and the like can be used.

Unlike the illustrative embodiment, when the content reproduction device includes the display units 112 or when portable terminals each of which has a function of reproducing the contents is used in the vehicle, the change processing of step S30 may be executed only for the display unit 112 or the portable terminal that the driver is seeing. The reason is that the change processing of step S30 may cause a passenger except for the driver to feel uncomfortable.

Whether the display unit 112 is a display unit that the driver is seeing may be determined by a provision position of the display unit 112, for example. Also, an in-vehicle camera configured to capture a vehicle interior may be provided, a driver's gaze may be detected from a captured image of the in-vehicle camera, and the display unit 112 that the driver is seeing may be specified on the basis of the driver's gaze. In order to determine whether the portable terminal is a portable terminal that the driver is seeing, each portable terminal may be registered in advance, and a portable terminal that the driver is seeing may be registered by communication with a near-field wireless communication device provided to the steering of the vehicle.

In the meantime, when it is determined that the driver is sleeping from a captured image of the in-vehicle camera, the change processing of step S30 may be executed for the display unit 112 or the portable terminal that a passenger except for the driver is seeing. Thereby, it may be expected that the passenger except for the driver awakes the driver and enables the driver to make a preparation for the manual driving. When the passenger except for the driver is a child, a content (for example, a horror movie or the like) causing the child to feel dangerous may be reproduced. Thereby, even when the child does not understand the meaning of the change processing of step S30 well, it may be expected that the child will awake the driver. In the meantime, whether the passenger except for the driver is a child may be determined by pattern-recognizing a face in a captured image of the in-vehicle camera, for example. Also, when all passengers are sleeping, a warning sound may be generated in the change processing of step S30, for example.

Unlike the above illustrative embodiment, in the flow operation of FIG. 6, only the processing of steps S40 to S60 may be executed without executing the processing of steps S10 to S30. In this case, it is not possible to accomplish the effect that it is possible to appropriately notify the user that the vehicle driving is to be switched from the automatic driving to the manual driving. However, it is possible to switch the vehicle driving from the automatic driving to the manual driving in accordance with the user's intention, so that it is possible to improve the convenience. Therefore, the content reproduction device or content reproduction method of executing only the processing of steps S40 to S60 may also be implemented.

What is claimed is:

1. A content reproduction device comprising:
an acquisition unit configured to acquire driving information indicating whether a vehicle driving is a manual driving in which a driver should execute a driving operation or an automatic driving in which the driver does not have to execute the driving operation, and
a change unit that is configured to determine whether the vehicle driving is to be switched from the automatic driving to the manual driving on the basis of the driving information acquired by the acquisition unit and that, when the vehicle driving is switched from the automatic driving to the manual driving, changes at least one of a content to be reproduced and a setting about reproduction.

2. The content reproduction device according to claim 1,
wherein the driving information comprises pre notice information, which notices in advance that the vehicle driving is to be switched from the automatic driving to the manual driving, and
wherein the change unit changes at least one of the content to be reproduced and the setting about reproduction into a first changed content after a notice is made by the pre notice information until the vehicle driving is actually switched from the automatic driving to the manual driving, and changes at least one of the content to be reproduced and the setting about reproduction into a second changed content different from the first changed content at a point of time at which the vehicle driving is switched from the automatic driving to the manual driving.

3. The content reproduction device according to claim 1, further comprising:
an operation unit that is to be operated by a user, and
a determination unit configured to determine whether the user has an intention to switch the vehicle driving from the automatic driving to the manual driving, based on an operation content performed on the operation unit for changing at least one of the content to be reproduced and the setting about reproduction.

4. The content reproduction device according to claim 3, wherein the determination unit is configured to determine whether the user has an intention to switch the vehicle driving from the automatic driving to the manual driving, based on a traveling situation of the vehicle.

5. The content reproduction device according to claim 3, wherein when the vehicle driving is switched from the automatic driving to the manual driving in correspondence to a determination result of the determination unit, and when the vehicle driving is switched from the automatic driving to the manual driving, irrespective of the determination result of the determination unit, contents of the change, which is to be executed by the change unit, are different.

6. A content reproduction method comprising:
an acquisition process of acquiring driving information indicating whether a vehicle driving is a manual driving in which a driver should execute a driving operation or an automatic driving in which the driver does not have to execute the driving operation, and
a change processing of determining whether the vehicle driving is to be switched from the automatic driving to the manual driving on the basis of the driving information acquired by the acquisition unit and, when the vehicle driving is switched from the automatic driving to the manual driving, changing at least one of a content to be reproduced and a setting about reproduction.
